(19) United States
(12) Patent Application Publication
(10) Pub. No.: US 2016/0210323 A1
(43) Pub. Date: Jul. 21, 2016

(54) TEMPORAL AUDITING

(71) Applicant: International Business Machines Corporation, Armonk, NY (US)

(72) Inventors: Yao-Ching S. Chen, Saratoga, CA (US); Maria Sueli de Almeida, San Jose, CA (US); Xiaohong Fu, Milpitas, CA (US); Krishnarao G. Kulkarni, San Jose, CA (US); Jan-Eike Michels, San Jose, CA (US); James W. Pickel, Gilroy, CA (US)

(21) Appl. No.: 14/598,431

(22) Filed: Jan. 16, 2015

(51) Int. Cl. G06F 17/30; G06F 11/34

(52) U.S. Cl. CPC G06F 17/30368; G06F 11/3438; G06F 17/30377; G06F 17/30575

(57) ABSTRACT

A method for temporal tracking of data changes in a database management system is provided. The method may include receiving a plurality of modified data change tracking parameters associated with the database management system, whereby the plurality of modified data change tracking parameters are received through a user interface. The method may also include applying the modified plurality of data change tracking parameters to the database management system. The method may further include tracking the data changes based on the plurality of modified change tracking parameters, whereby the tracking is performed automatically.

### DISCLOSURES BY THE INVENTORS OR JOINT INVENTORS

Aspects of the present invention have been disclosed by the Applicant, who obtained the subject matter disclosed directly from the inventors, in the product IBM® DB2® Version 11.1 for z/OS (DB2 11 for z/OS) made available to the public on Oct. 10, 2014.

### BACKGROUND

The present invention relates generally to the field of computers, and more particularly to database auditing.

Database auditing involves observing a database in order to be aware of the actions of database users. As such, database administrators and consultants often set up auditing for security purposes, such as to ensure that those without the permission to access information do not access it. In a database system, auditing may be very important in order to meet regulatory compliance requirements, enable action accountability, investigate and track database activities, etc. Therefore, it may be a common requirement to monitor the users of the database so as to see who did what, how, when, and where.

### SUMMARY

According to one embodiment, a method for temporal tracking of data changes in a database management system is provided. The method may include receiving a plurality of modified data change tracking parameters associated with the database management system, whereby the plurality of modified data change tracking parameters are received through a user interface. The method may also include applying the modified plurality of data change tracking parameters to the database management system. The method may further include tracking the data changes based on the plurality of modified change tracking parameters, whereby the tracking is performed automatically.

According to another embodiment, a computer system for temporal tracking of data changes in a database management system is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving a plurality of modified data change tracking parameters associated with the database management system, whereby the plurality of modified data change tracking parameters are received through a user interface. The method may also include applying the modified plurality of data change tracking parameters to the database management system. The method may further include tracking the data changes based on the plurality of modified change tracking parameters, whereby the tracking is performed automatically.

According to yet another embodiment, a computer program product for temporal tracking of data changes in a database management system is provided. The computer program product may include one or more computer-readable storage devices and program instructions stored on at least one of the one or more tangible storage devices, the program instructions executable by a processor. The computer program product may include program instructions to receive a plurality of modified data change tracking parameters associated with the database management system, whereby the plurality of modified data change tracking parameters are received through a user interface. The computer program product may also include program instructions to apply the modified plurality of data change tracking parameters to the database management system. The computer program product may further include program instructions to track the data changes based on the plurality of modified change tracking parameters, whereby the tracking is performed automatically.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIGS. 2A-2B are an example of temporal auditing based on table-level specifications according to at least one embodiment;

FIGS. 3A-3C are operational flowcharts illustrating the steps carried out by a program for temporal auditing according to at least one embodiment; and

FIG. 4 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to database auditing. The following described exemplary embodiments provide a system, method and program product to, among other things, provide a temporal tracking of data changes in a database management system. Additionally, the present embodiment has the capacity to improve the technical field of auditing a database by dynamically modifying data change tracking parameters through a user interface (UI) to the database management system. Furthermore, the present embodiment has the potential to automatically track the data changes based on the modified data change tracking parameters.

As previously described, in a database system, auditing may be very important in order to meet regulatory compliance requirements, enable action accountability, investigate and track database activities, etc. Therefore, it may be a common requirement to monitor the users of the database so as to see who did what, how, when, and where. However, without integrated support in the database management system, complex application logic (e.g., usage of complex triggers) is usually needed which can result in large maintenance overhead and poor performance. Furthermore, some database systems, including DB2® (DB2 and all DB2-based trademarks and logos are trademarks or registered trademarks of IBM and/or its affiliates), may provide audit trace as an option; however, such an option may provide limited capability to effectively store, query, and analyze the audit trace records. Additionally, existing approaches to application level tracking may add complexity and error prone code to the application. As such, it may be advantageous, among other things, to implement a method and apparatus to track the data-change operations (e.g. the WHO, HOW, WHEN, WHAT, and WHERE) automatically in a database management system, such as DB2®. Therefore, as the application logic (i.e., trigger logic) is being put into the database, the performance may be improved for this type of functionality.

According to at least one implementation, the present embodiment may include an integrated database management auditing solution which may provide good performance, ease of use, less maintenance overhead and generic information tracking. Currently a system-time versioning feature along with temporal tables has been introduced for some database management systems, such as DB2® 10 for z/OS that provides a solution to manage different versions of application data. As such, the database management system, such as DB2® will automatically keep track of when rows are created, updated, and deleted from system-period temporal table. Therefore, columns ROW BEGIN and ROW END of system-period temporal table are used and populated by DB2® based on the system clock.

Although the present embodiment may be implemented with respect to various database management systems, DB2® may be used for example purposes only. The present embodiment may provide a new table-level specification where more columns are added to temporal tables and automatically populated by the database management system, such as DB2® according to the nature of data-change operations and the user. According to at least one implementation, in addition to the DB2® 10 feature described above, the present embodiment may provide a more comprehensive tracing solution to track database changes, such as who, how, and what, which may be more relevant in today's information management. As such, once the schema foundation is established, “plug-ins” with different values of a global variable, a special register, and a session variable may enable different audits to satisfy multiple tracking needs. Existing approaches to application level tracking may not only explode the table design, but may also add complexity and error prone code to the application. Therefore, as the application logic is being put into the database, the performance may be better for the functionality of a more comprehensive tracing solution. In addition, management of such an application may also be simplified. Furthermore, the integrated solution based on a system-period temporal table may also enable the temporal query for applications.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product to provide a temporal tracking of data changes in a database management system. Embodiments of the present invention may be based on the improvements of table-level specifications. For example, according to one implementation, the column definition of CREATE TABLE and ALTER TABLE statements may be extended with an “as-generated-expression-clause” following the GENERATED ALWAYS attribute. As such, a user may specify the information to be audited and the information to be traced and then DB2® may handle the other aspects. According to the present embodiment, the global variable in the as-generated-expression-clause may be system built-in (e.g., system generated or pre-defined) or the global variable may be user-defined. The ON DELETE ADD EXTRA ROW specification in the ALTER TABLE statement tells DB2® to differentiate WHO deleted the record, which is an extra data propagation to the history table.

Therefore, once the table is defined, “plug-ins” with different values of the global variable, special register, or session variable may enable different audits to satisfy multiple tracking needs. As previously explained, such an implementation may simplify the management of applications, such as DB2®. Furthermore, such a continued integrated solution based on a system-period temporal table for temporal auditing may also enable the temporal query for applications.

According to the present embodiment, different models may be built depending on how a user defines the columns of the active table or history table with the GENERATED ALWAYS attribute followed by the as-generated-expression-clause. For illustration purposes, two models will be used along with examples to illustrate the integrated solution. The first example is one that describes a model that traces the life cycle of a record of a bank account: from birth (insert) to changes (updates), and in the end, to death (delete). In a DB2® system-period temporal table, ROW BEGIN and ROW END columns must be defined with TIMESTAMP(12) data type (with or without time zone). However, for example purposes, rather than using timestamp values with precision 12, an integer value and a “max” value to represent the system-period timestamp and the maximum timestamp value generated by DB2® may be used respectively for readability. The second example describes a model that tracks two primary authorization IDs.

### 1. EXAMPLE ONE

### Schema of System-Period Temporal Table

1.1 Define global variable TRANS_LOCATION_VAR:
CREATE VARIABLE trans_location_var VARCHAR(100);
1.2 Create current table that stores current data, e.g., the most current information of a bank account:

CREATE bank_account_stt
(account_no INT NOT NULL,
balance INT,
user_id VARCHAR(128) GENERATED ALWAYS AS
(SESSION_USER),
trans_location VARCHAR(128) GENERATED ALWAYS AS
(TRANS_LOCATION_VAR),
op_code CHAR(1) GENERATED ALWAYS AS (DATA CHANGE
OPERATION),
sys_start TIMESTAMP(12) NOT NULL GENERATED ALWAYS AS
ROW BEGIN,
sys_end TIMESTAMP(12) NOT NULL GENERATED ALWAYS AS
ROW END,
trans_id TIMESTAMP(12) GENERATED ALWAYS AS
TRANSACTION START ID,
...
PERIOD SYSTEM_TIME(sys_start, sys_end));

With respect to the above example:
a. Column “sys_start” is defined with GENERATED ALWAYS AS ROW BEGIN attribute, it tells DB2 to track WHEN a new record is born: it can be inserted into the table, or it can be a result of an update operation.
b. Column “sys_end” is defined with GENERATED ALWAYS AS ROW END attribute, it tells DB2 to track WHEN a record is no longer of the most current “version”: it can be deleted from current table and automatically moved to history table by DB2, or it can be a result of an update operation. Given any current record, the value of sys_end is the maximum timestamp value (here we use “max” to represent).
c. Column “user_id” is defined with GENERATED ALWAYS AS special_register SESSION_USER attribute, it tells DB2 to track WHO created or modified the record. In addition to special registers, global variables and session variables can also be used to satisfy different auditing needs.
d. Column “translocation” is defined with GENERATED ALWAYS AS user-defined global variable TRANS_LOCATION_VAR attribute, it tells DB2 to track WHERE the transaction was processed. In addition to user-defined global variables, system built-in global variables may be allowed too.
e. Column “op_code” is defined with GENERATED ALWAYS AS (DATA CHANGE OPERATION) attribute, it tracks WHAT data-change operation occurred on the record; combined with the historical record information, it is feasible to investigate HOW the record is changed. For MERGE statement, the underneath INSERT, UPDATE, and DELETE operation will be used for tracking.
1.3 Create history table that stores historical data, e.g., the old information of a bank account:

CREATE bank_account_hist
(account_no INT NOT NULL,
balance INT,
user_id VARCHAR(128),
trans_location VARCHAR(128),
op_code CHAR(1),
sys_start TIMESTAMP(12) NOT NULL,
sys_end TIMESTAMP(12) NOT NULL,
trans_id TIMESTAMP(12),
...);

1.4 Alter table to build the link:
ALTER TABLE bank_account_stt ADD VERSIONING USE HISTORY TABLE bank_account_hist ON DELETE ADD EXTRA ROW;

### 2. EXAMPLE TWO

### The Life Cycle of a Bank Account Record

2.1 At time 2, location San Jose in Calif., Claire inserts a row into bank_account_stt table (account_no “13452”, balance $2000):
SET trans_location_var =‘San Jose, Calif.’;
INSERT INTO bank_account_stt (account_no, balance) VALUES (13452, 2000);

Current table BANK_ACCOUNT_STT:

| account_no | balance | user_id | trans_location | op_code | sys_start | sys_end | . . . |
|---|---|---|---|---|---|---|---|
| 13452 | $2000 | Claire | San Jose, CA | ‘I’ | 2 | max | . . . |

History table BANK_ACCOUNT_HIST (empty):

| account_no | balance | user_id | trans_location | op_code | sys_start | sys_end | . . . |
|---|---|---|---|---|---|---|---|

2.2 At time 6, location San Francisco in California, Steve updates the row increasing $500 balance
(account_no “13452”, balance $2500):
SET trans_location_var =‘San Francisco, Calif.’;
UPDATE bank_account_stt SET balance=balance+500;

Current table BANK_ACCOUNT_STT:

| account_no | balance | user_id | trans_location | op_code | sys_start | sys_end | . . . |
|---|---|---|---|---|---|---|---|
| 13452 | $2500 | Steve | San Francisco, CA | ‘U’ | 6 | max | . . . |

History table BANK_ACCOUNT_HIST:

| account_no | balance | user_id | trans_location | op_code | sys_start | sys_end | . . . |
|---|---|---|---|---|---|---|---|
| 13452 | $2000 | Claire | San Jose, CA | ‘I’ | 2 | 6 | . . . |

2.3. At time 15, location Fremont in Calif., Rick deletes the row of account_no “13452” (account_no “13452”, balance $2500, removed from current table):
SET trans_location_var =‘Fremont, Calif.’;
DELETE FROM bank_account_stt;

Current table BANK_ACCOUNT_STT (empty):

| account_no | balance | user_id | trans_location | op_code | sys_start | sys_end | . . . |
|---|---|---|---|---|---|---|---|

History table BANK_ACCOUNT_HIST:

| account_no | balance | user_id | trans_location | op_code | sys_start | sys_end | . . . |
|---|---|---|---|---|---|---|---|
| 13452 | $2000 | Claire | San Jose, CA | ‘I’ | 2 | 6 | . . . |
| 13452 | $2500 | Steve | San Francisco, CA | ‘U’ | 6 | 15 | . . . |
| 13452 | $2500 | Rick | Fremont, CA | ‘D’ | 15 | 16 | . . . |

To interpret the history table rows:
For the 1st row, it tells that Claire inserted row at time 2 and San Jose with balance $2000, and the row was valid until time 6.
For the 2nd row, it tells that Steve updated it at time 6 and San Francisco with new balance $2500, and the row was valid until time 15.
For the 3rd row, it tells that Rick deleted the row at time 15 and Fremont, the balance was $2500 at delete time.
   The 2nd row and 3rd row are identical for user data (e.g., account_no and balance). The DB2 z/OS temporal query request will be modified to never return the 3rd row from history table. The location of transaction (translocation column) is tracked by defining and setting a global variable. This is the most flexible and generic way for application to track any information. The application just needs to set the global variable before data-change operations like insert, update, delete, and merge.

### 3. EXAMPLE THREE

### Another Model Aligned with Temporal System-Time Period

With the temporal auditing scheme discussed in the example above, the present embodiment provides a flexible way for auditing. Here is an example of another model that audits two user IDs to be aligned with temporal period. The beg_user_id and end_user_id columns are used to audit the user_id associated with the temporal system start time and temporal system end time.
3.1 Create current table that stores current data, e.g., the most current information of a bank account:

CREATE bank_account_stt
(account_no INT NOT NULL,
balance INT,
beg_user_id VARCHAR(128) GENERATED ALWAYS AS
(SESSION_USER),
end_user_id VARCHAR(128) DEFAULT NULL,
op_code CHAR(1) GENERATED ALWAYS AS (DATA CHANGE
OPERATION),
sys_start TIMESTAMP(12) NOT NULL GENERATED ALWAYS AS
ROW BEGIN,
sys_end TIMESTAMP(12) NOT NULL GENERATED ALWAYS AS
ROW END,
trans_id TIMESTAMP(12) GENERATED ALWAYS AS
TRANSACTION START ID,
...
PERIOD SYSTEM_TIME(sys_start, sys_end));

3.2 Create history table that stores historical data, e.g., the old information of a bank account:

CREATE bank_account_hist
(account_no INT NOT NULL,
balance INT,
beg_user_id VARCHAR(128),
end_user_id VARCHAR(128) GENERATED ALWAYS AS
(SESSION_USER),
op_code CHAR(1) GENERATED ALWAYS AS (DATA CHANGE
OPERATION),
sys_start TIMESTAMP(12) NOT NULL,
sys_end TIMESTAMP(12) NOT NULL,
trans_id TIMESTAMP(12),
...);

3.3 Alter table to build the link:
ALTER TABLE bank_account_stt ADD VERSIONING USE HISTORY TABLE bank_account_hist;
3.4 The life cycle of a bank account record
3.4.1 At time 2, Claire inserts a row into bank_account_stt table (account_no “13452”, balance $2000):

Current table BANK_ACCOUNT_STT:

| account_no | balance | beg_user_id | end_user_id | op_code | sys_start | sys_end | . . . |
|---|---|---|---|---|---|---|---|
| 13452 | $2000 | Claire | NULL | ‘I’ | 2 | max | . . . |

History table BANK_ACCOUNT_HIST (empty):

| account_no | balance | beg_user_id | end_user_id | op_code | sys_start | sys_end | . . . |
|---|---|---|---|---|---|---|---|

3.4.2 At time 6, Steve updates the row increasing $500 balance (account_no “13452”, balance $2500):

Current table BANK_ACCOUNT_STT:

| account_no | balance | beg_user_id | end_user_id | op_code | sys_start | sys_end | . . . |
|---|---|---|---|---|---|---|---|
| 13452 | $2500 | Steve | NULL | ‘U’ | 6 | max | . . . |

History table BANK_ACCOUNT_HIST:

| account_no | balance | beg_user_id | end_user_id | op_code | sys_start | sys_end | . . . |
|---|---|---|---|---|---|---|---|
| 13452 | $2000 | Claire | Steve | ‘U’ | 2 | 6 | . . . |

3.4.3 At time 15, Rick deletes the row of account_no “13452” (account_no “13452”, balance $2500, removed from current table):

Current table BANK_ACCOUNT_STT (empty):

| account_no | balance | beg_user_id | end_user_id | op_code | sys_start | sys_end | . . . |
|---|---|---|---|---|---|---|---|

History table BANK_ACCOUNT_HIST:

| account_no | balance | beg_user_id | end_user_id | op_code | sys_start | sys_end | . . . |
|---|---|---|---|---|---|---|---|
| 13452 | $2000 | Claire | Steve | ‘U’ | 2 | 6 | . . . |
| 13452 | $2500 | Steve | Rick | ‘D’ | 6 | 15 | . . . |

3.4.4 Summary of the auditing purpose of this model
   After the insert of a row, then an update on the row, followed by a delete, there are 2 rows in history table:
   For the 1st row, it tells that the row started from Claire at time 2 and was updated by Steve at time 6. Whether Claire inserted or updated the row, it depends on the previous row in temporal sequence. For this case, there is no previous version of the record, so it can be deducted that Claire created the row via insert into current table.
   For the 2nd row, it tells that the row started from Steve at time 6 was deleted by Rick at time 15.

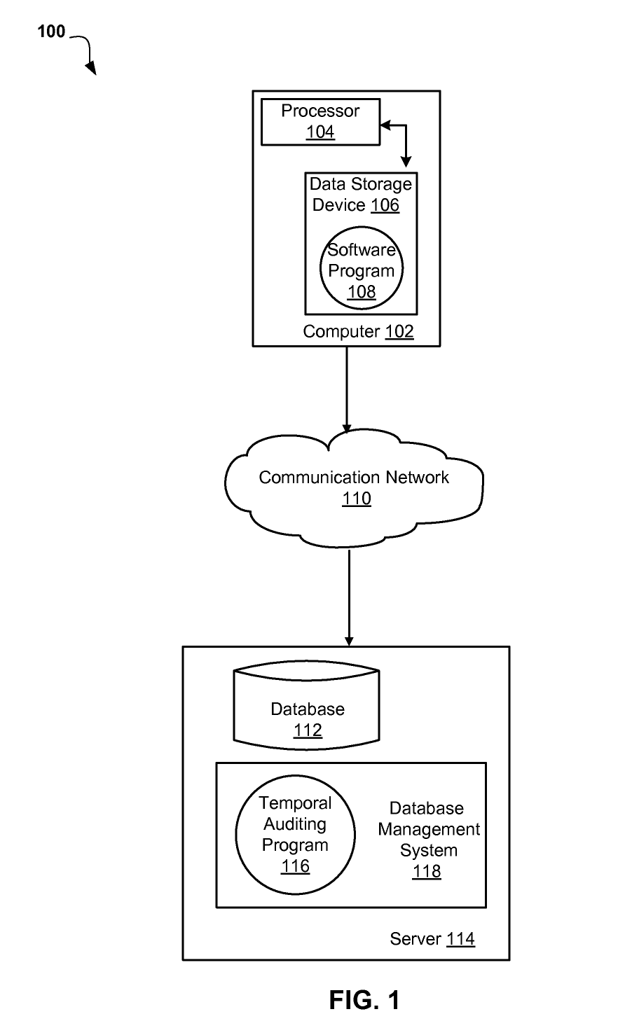

Referring to FIG. 1, an exemplary networked computer environment 100 in accordance with one embodiment is depicted. The networked computer environment 100 may include a computer 102 with a processor 104 and a data storage device 106 that is enabled to run a software program 108. The networked computer environment 100 may also include a server 114 that is enabled to run a Temporal Auditing Program 116 that interacts with a database management system 118, a database 112, and a communication network 110. The networked computer environment 100 may include a plurality of computers 102 and servers 114, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

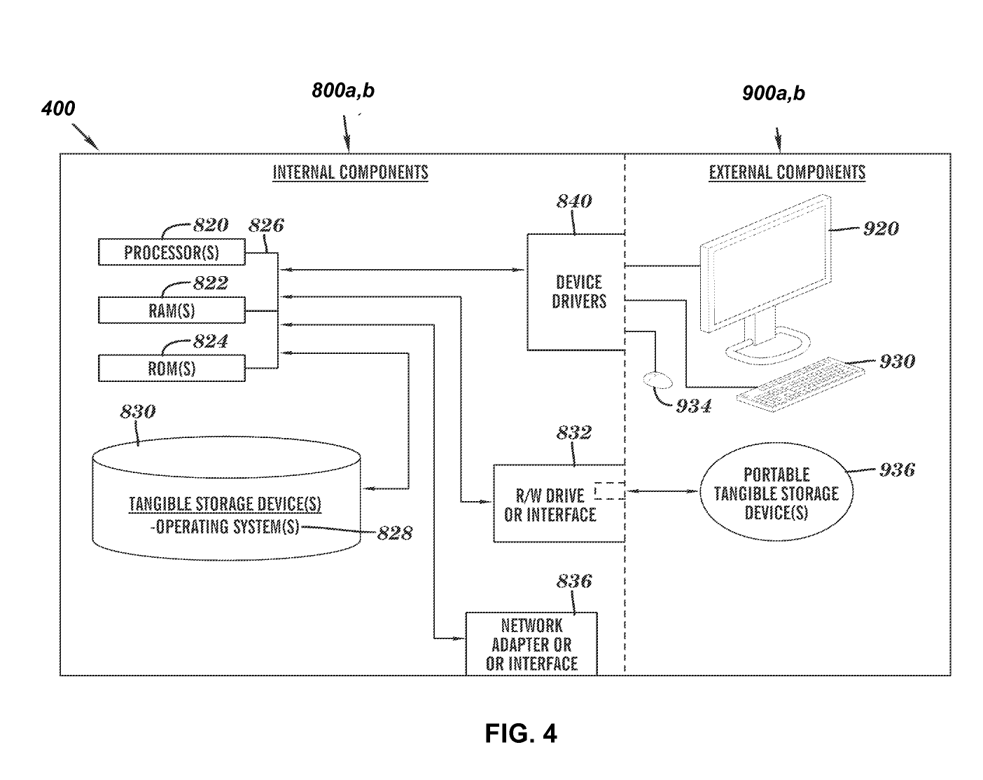

The client computer 102 may communicate with database 112 running on server computer 114 via the communications network 110. The communications network 110 may include connections, such as wire, wireless communication links, or fiber optic cables. As will be discussed with reference to FIG. 4, server computer 114 may include internal components 800a and external components 900a, respectively, and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing devices capable of running a program, accessing a network, and accessing a database 112.

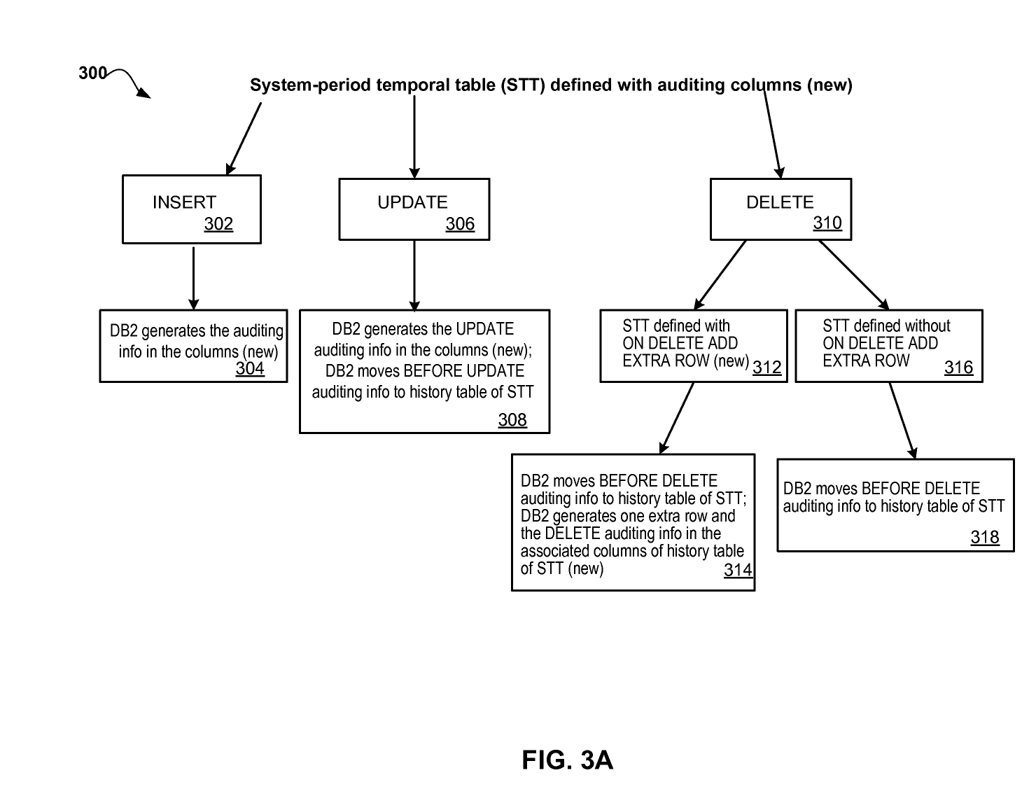

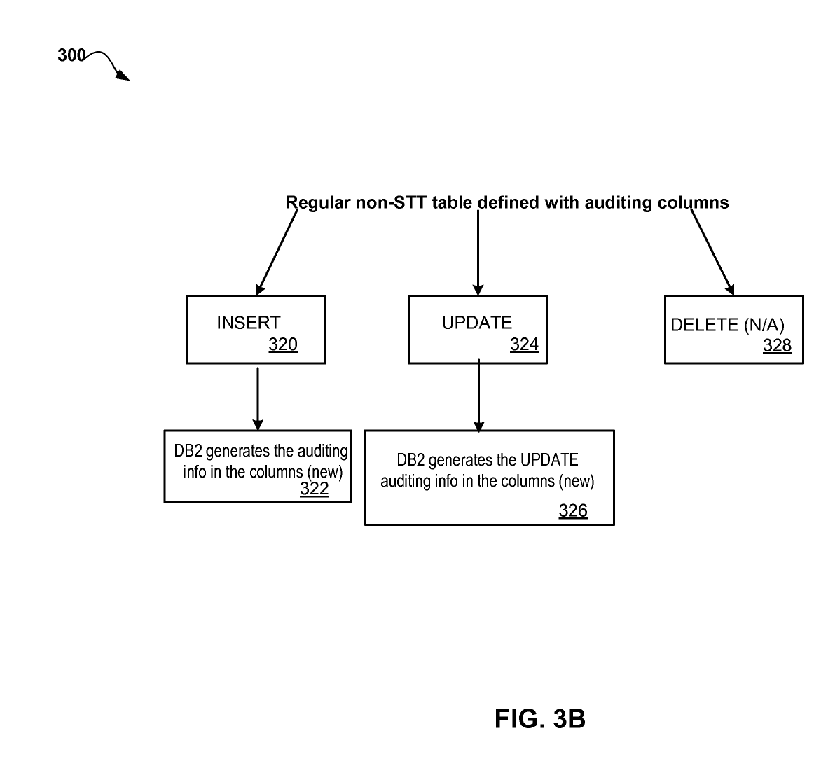

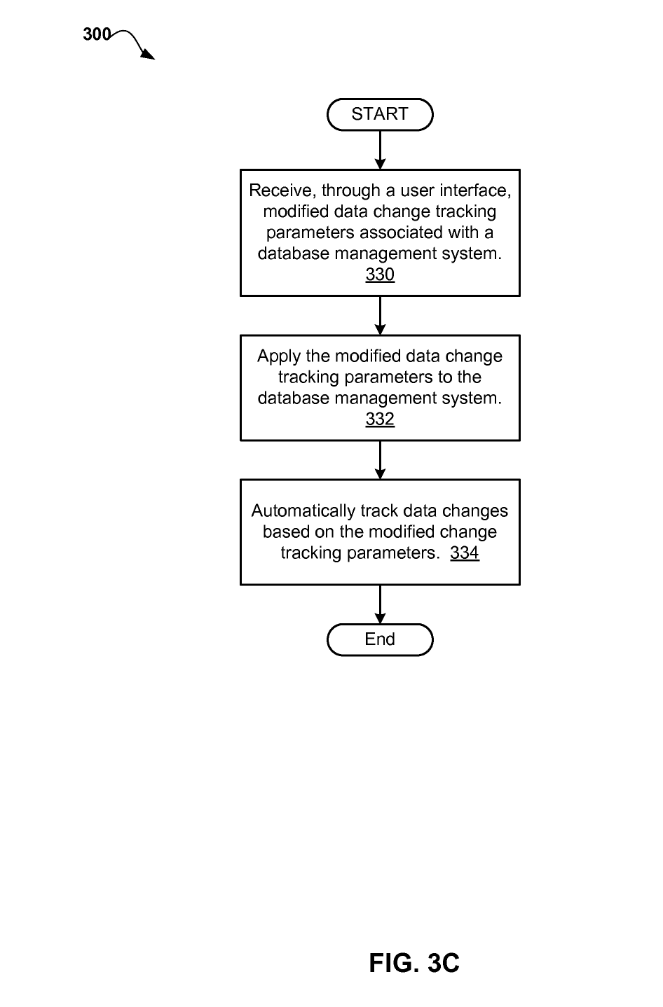

As previously described, the client computer 102 may access database 112, running on server computer 114 via the communications network 110. For example, a user using an application program 108 running on a client computer 102 may connect via a communication network 110 to database 112 which may be running on server computer 114. Additionally, the user may utilize the Temporal Auditing Program 116 running on server 114 to dynamically modify data change tracking parameters through a user interface (UI) to a data management system 118 that manages a database 112 and automatically track the data changes based on the modified data change tracking parameters. The Temporal Auditing method is explained in more detail below with respect to FIGS. 3A-3C.

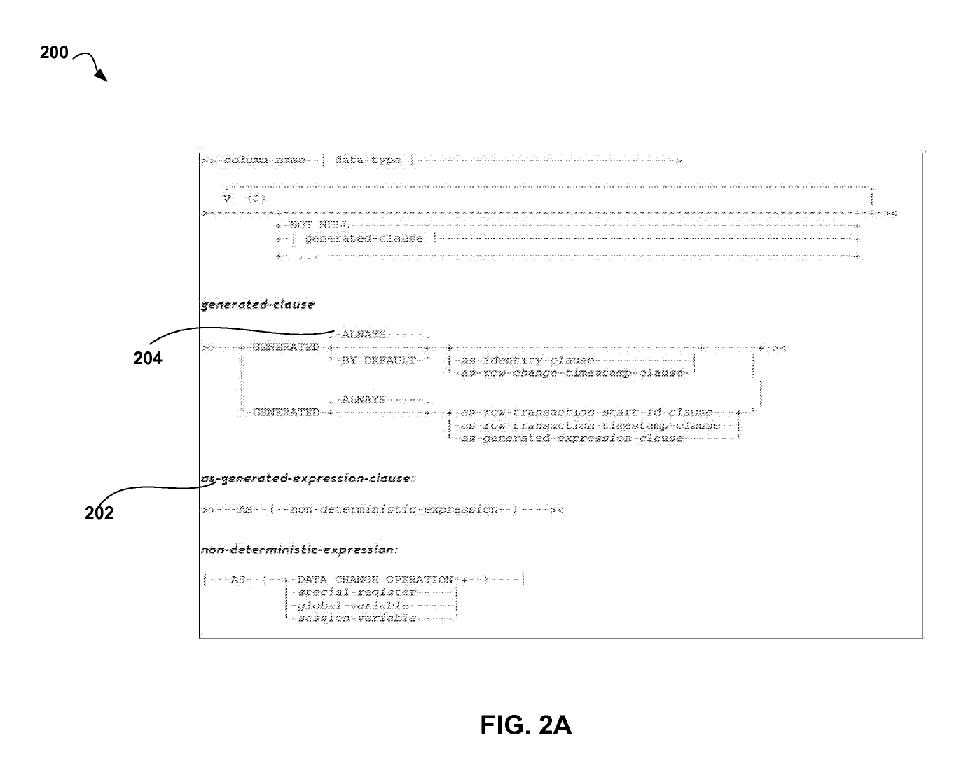

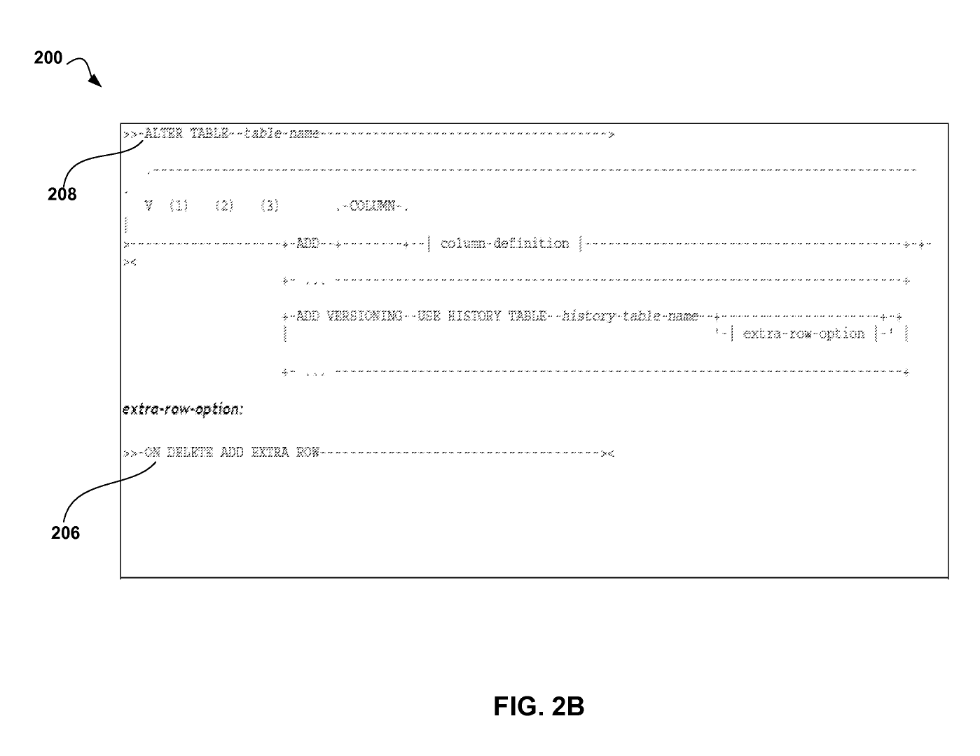

Referring now to FIGS. 2A-2B, an example 200 of temporal auditing based on table-level specifications according to at least one embodiment is depicted. As previously described, the column definition of CREATE TABLE and ALTER TABLE statements may be extended with an “as-generated-expression-clause” 202 following the GENERATED ALWAYS attribute 204. As such, a user may specify the information to be audited and the information to be traced and then DB2® may handle the other aspects. According to the present embodiment, the global variable in the “as generated-expression-clause” 202 may be system built-in (e.g., system generated or pre-defined) or the global variable may be user-defined. Furthermore, the ON DELETE ADD EXTRA ROW 206 specification in the ALTER TABLE 208 statement tells DB2® to differentiate WHO deleted the record, which is an extra data propagation to the history table.

Referring now to FIGS. 3A-3B, operational flowcharts 300 illustrating the steps carried out by a program for temporal auditing according to at least one embodiment is depicted. As previously indicated, the present embodiment may be implemented with respect to various database management systems, however for illustration purposes only, DB2® is used as an example with respect to one implementation.

FIG. 3A illustrates a system-period temporal table (STT) defined with auditing columns. According to the present embodiment, if a user specifies the GENERATE ALWAYS clause, then DB2® will automatically generate the auditing information in the columns. As such, at 302, when an INSERT operation is initiated, DB2® generates the auditing information in the columns at 304. At 306, when an UPDATE operation is initiated, DB2® generates the UPDATE auditing information in the columns and DB2® moves BEFORE UPDATE auditing information to the history table of the STT at 308. For example, DB2® may record information, such as WHO updated the table and WHEN the table was updated to the history table of the STT.

At 310, when a DELETE operation is initiated, the STT is defined with ON DELETE ADD EXTRA ROW at 312. Then at 314, DB2® moves BEFORE DELETE auditing information to the history table of the STT. Additionally, DB2® generates one extra row and the DELETE auditing information in the associated columns of the history table of the STT. For example, information such as WHO deleted the record may be added to the history table of the STT. Furthermore, when a DELETE operation is initiated, the STT is defined without ON DELETE ADD EXTRA ROW at 316. Then at 318, DB2® moves BEFORE DELETE auditing information to the history table of the STT.

FIG. 3B illustrates a regular non-STT table defined with auditing columns. As such, at 320, when an INSERT operation is initiated, DB2® generates the auditing information in the columns at 322. At 324, when an UPDATE operation is initiated, DB2® generates the UPDATE auditing information in the columns at 326. The DELETE function 328 is not applicable with respect to this example.

According to the present embodiment, the auditing columns may be defined with the GENERATED ALWAYS clause. As such, the auditing columns may be used to track the following:
1. WHO modified the record (via CURRENT SQLID, USER special registers)
2. WHAT kind of data change operation modified the data, is it an INSERT, UPDATE, or DELETE? (via DATA CHANGE OPERATION)
3. WHEN the data is modified (via ROW BEGIN and ROW END columns of STT)
4. More auditing information as shown in the following list:

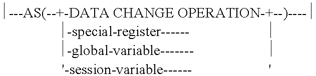

special-register:

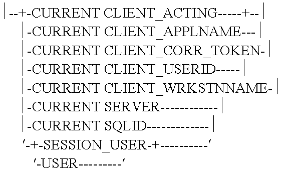

session-variable:

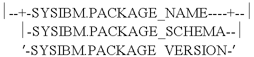

FIG. 3C illustrates a method for temporal tracking of data changes in a database management system. At 330, modified data change tracking parameters associated with a database management system are received through a user interface. As such, the Temporal Auditing Program 116 (FIG. 1) may receive modified data change tracking parameters associated with a database management system 118 (FIG. 1). According to at least one implementation of the present embodiment, the modified data change tracking parameters may be received via a user interface. For example, a user using a computer 102 (FIG. 1) may utilize a software program with a user interface 108 (FIG. 1) to modify data change tracking parameters associated with a database management system 118 (FIG. 1). The user interface may support tracking parameters selected from a group consisting of WHO, HOW, WHEN, WHAT, WHERE, and other user-defined information.

Then at 332, the modified data change tracking parameters are applied to the database management system. As such the Temporal Auditing Program 116 (FIG. 1) may apply the modified data change tracking parameters to the database management system 118 (FIG. 1) by utilizing methods selected from a group consisting of plug-ins with different values using global variables, special registers, and session variables.

Next at 334, the data changes are automatically tracked based on the modified change tracking parameters. According to one implementation, the Temporal Auditing Program 116 (FIG. 1) may utilize a temporal table to automatically track the data changes. As such, the Temporal Auditing Program 116 (FIG. 1) may automatically track when a row is created, updated, and deleted from a system-period temporal table.

It may be appreciated that FIGS. 3A-3C provide only an illustration of one implementation and do not imply any limitations with regard to how different embodiments may be implemented. Many modifications to the depicted environments may be made based on design and implementation requirements.

The present embodiment may improve existing technology, such as DB2® 10 for z/OS which introduced a system-time versioning feature along with temporal tables that provides a solution to manage different versions of application data. As such, DB2® automatically keeps track of when rows are created, updated, and deleted from system-period temporal table. Columns ROW BEGIN and ROW END of system-period temporal table are used and populated by DB2® based on the system clock. However, with the new table-level specification included in the present embodiment, more columns may be added to temporal tables and automatically populated by DB2® according to the nature of data-change operations and the user.

Advantages of the present embodiment may include, and are not limited to ease of use since once the table is defined, “plug-ins” with different values of a global variable, special registers and session variables may enable different audits to satisfy multiple tracking needs. As previously described, existing approaches to application level tracking adds complexity and error prone code to the application. Therefore, based on various implementations of the present embodiment, as the application logic (i.e. trigger logic) is being put into the database, the performance may be better for this type of functionality and management of this type of application may also be simplified.

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1) and network server 114 (FIG. 1) may include respective sets of internal components 800a,b and external components 900a,b illustrated in FIG. 4. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and the Software Program 108 (FIG. 1) in client computer 102 (FIG. 1) and the Temporal Auditing Program 116 (FIG. 1) in network server 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the Temporal Auditing Program 116 (FIG. 1) can be stored on one or more of the respective portable computer-readable tangible storage devices 936, read via the respective R/W drive or interface 832 and loaded into the respective hard drive 830.

Each set of internal components 800a,b also includes network adapters or interfaces 836 such as a TCP/IP adapter cards, wireless Wi-Fi interface cards, or 3G or 4G wireless interface cards or other wired or wireless communication links. The Software Program 108 (FIG. 1) in client computer 102 (FIG. 1) and the Temporal Auditing Program in network server 114 (FIG. 1) can be downloaded to client computer 102 (FIG. 1) and network server 114 (FIG. 1), respectively, from an external computer via a network (for example, the Internet, a local area network or other, wide area network) and respective network adapters or interfaces 836. From the network adapters or interfaces 836, the Software Program 108 (FIG. 1) in client computer 102 (FIG. 1) and the Temporal Auditing Program 116 (FIG. 1) in network server 114 (FIG. 1) are loaded into the respective hard drive 830. The network may comprise copper wires, optical fibers, wireless transmission, routers, firewalls, switches, gateway computers and/or edge servers.

Each of the sets of external components 900a,b can include a computer display monitor 920, a keyboard 930, and a computer mouse 934. External components 900a,b can also include touch screens, virtual keyboards, touch pads, pointing devices, and other human interface devices. Each of the sets of internal components 800a,b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for temporal tracking of data changes in a database management system, the method comprising:
receiving a plurality of modified data change tracking parameters associated with the database management system, wherein the plurality of modified data change tracking parameters are received through a user interface;
applying the modified plurality of data change tracking parameters to the database management system; and
tracking the data changes based on the plurality of modified change tracking parameters, wherein the tracking is performed automatically.

2. The method of claim 1, wherein the tracking the data changes comprises a temporal table to track the data changes.

3. The method of claim 1, wherein the user interface supports a plurality of tracking parameters.

4. The method of claim 3, wherein the plurality of tracking parameters comprises at least one of WHO, HOW, WHEN, WHAT, WHERE, and a plurality of user-defined information.

5. The method of claim 1, wherein the applying the modified plurality of data change tracking parameters further comprises:
utilizing at least one method selected from a plurality of methods.

6. The method of claim 5, wherein the plurality of methods comprises at least one of a plurality of plug-ins with at least one different value using at least one global variable, a plurality of special registers, and a plurality of session variables.

7. The method of claim 1, wherein the tracking the data changes comprises automatically tracking of when at least one row is created, updated, and deleted from a system-period temporal table.

8. A computer system for temporal tracking of data changes in a database management system, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving a plurality of modified data change tracking parameters associated with the database management system, wherein the plurality of modified data change tracking parameters are received through a user interface;
applying the modified plurality of data change tracking parameters to the database management system; and
tracking the data changes based on the plurality of modified change tracking parameters, wherein the tracking is performed automatically.

9. The computer system of claim 8, wherein the tracking the data changes comprises a temporal table to track the data changes.

10. The computer system of claim 8, wherein the user interface supports a plurality of tracking parameters.

11. The computer system of method of claim 10, wherein the plurality of tracking parameters comprises at least one of WHO, HOW, WHEN, WHAT, WHERE, and a plurality of user-defined information.

12. The computer system of claim 8, wherein the applying the modified plurality of data change tracking parameters further comprises:
utilizing at least one method selected from a plurality of methods.

13. The computer system of claim 12, wherein the plurality of methods comprises at least one of a plurality of plug-ins with at least one different value using at least one global variable, a plurality of special registers, and a plurality of session variables.

14. The computer system of claim 8, wherein the tracking the data changes comprises automatically tracking of when at least one row is created, updated, and deleted from a system-period temporal table.

15. A computer program product for temporal tracking of data changes in a database management system, the computer program product comprising:
one or more computer-readable storage devices and program instructions stored on at least one of the one or more tangible storage devices, the program instructions executable by a processor, the program instructions comprising:
program instructions to receive a plurality of modified data change tracking parameters associated with the database management system, wherein the plurality of modified data change tracking parameters are received through a user interface;
program instructions to apply the modified plurality of data change tracking parameters to the database management system; and
program instructions to track the data changes based on the plurality of modified change tracking parameters, wherein the tracking is performed automatically.

16. The computer program product of claim 15, wherein the tracking the data changes comprises a temporal table to track the data changes.

17. The computer program product of claim 15, wherein the user interface supports a plurality of tracking parameters.

18. The computer program product of claim 17, wherein the plurality of tracking parameters comprises at least one of WHO, HOW, WHEN, WHAT, WHERE, and a plurality of user-defined information.

19. The computer program product of claim 15, wherein the applying the modified plurality of data change tracking parameters further comprises:
utilizing at least one method selected from a plurality of methods.

20. The computer program product of claim 19, wherein the plurality of methods comprises at least one of a plurality of plug-ins with at least one different value using at least one global variable, a plurality of special registers, and a plurality of session variables.
